(19) United States
(12) Patent Application Publication
(10) Pub. No.: US 2011/0166959 A1
(43) Pub. Date: Jul. 7, 2011

(54) ENERGY MANAGEMENT INFORMATION SYSTEM

(75) Inventors: Frederick Winter, Castle Rock, CO (US); Elissa D. Sell, Woodland Park, CO (US); Marya Tognetti Swiger, Colorado Springs, CO (US); Christine Fye, Castle Rock, CO (US); Sue E. Battig, Woodland Park, CO (US); Chakrapani S. Kundeti, Colorodo Springs, CO (US)

(73) Assignee: VERIZON PATENT AND LICENSING, INC., Basking Ridge, NJ (US)

(21) Appl. No.: 12/683,508

(22) Filed: Jan. 7, 2010

(51) Int. Cl. G06Q 30/00; G06F 1/26

(52) U.S. Cl. 705/26.25; 705/14.1; 700/291

(57) ABSTRACT

An energy use optimization tool includes logic to receive inventory information relating to a plurality of customer devices and store the inventory information. The logic calculates an estimated energy cost associated with the plurality of customer devices based on the received inventory information. The logic also calculates energy savings or environmental impact information based on energy savings or environmental impact information associated with available service offerings compared to the estimated energy cost. The calculated energy savings or environmental impact information is output to a user.

### BACKGROUND

As the affects of energy consumption continue to be studied and explored, it has become increasingly beneficial for organizations to consider energy use and its corresponding cost and environmental impact. In a fiscal sense, as the monetary cost of energy continues to escalate, the effects of poor or sub-optimal energy management plans can have a large impact on an organization's operating budget. In an environmental sense, poor energy management can result in significant wasting of energy, even where the cost of alternatives is not necessarily lower. In both circumstances, it benefits individuals to accurately and effectively ascertain their energy options.

### BRIEF DESCRIPTION OF THE DRAWINGS

FIG. 1 illustrates a block diagram of an exemplary environment 100 in which systems and methods described herein may be implemented;

FIG. 2 is a diagram illustrating exemplary components of the service provider of FIG. 1;

FIG. 3 is a functional block diagram of exemplary components implemented in the service provider of FIG. 1;

FIGS. 4A-4D depict an exemplary interface associated with the interface logic of FIG. 3; and

FIG. 5 is a flow diagram illustrating exemplary processing associated with generating energy use recommendation reports in the embodiments described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the embodiments disclosed herein.

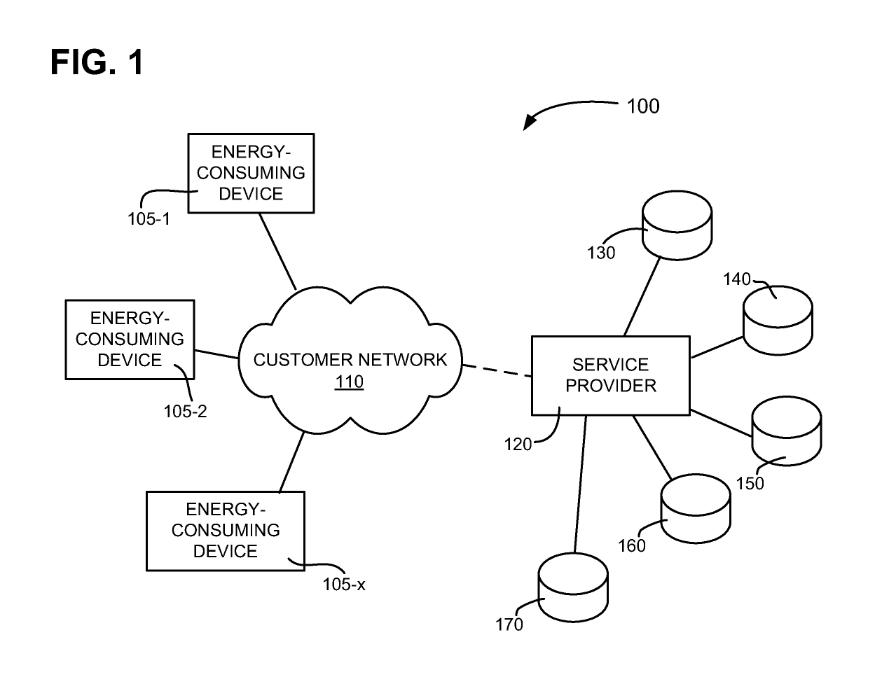

FIG. 1 is a block diagram of an exemplary environment 100 in which systems and methods described herein may be implemented. As shown, environment 100 may include a number of energy-consuming devices 105-1, 105-2, and 105-x (collectively “energy-consuming devices 105” and individually “energy-consuming device 105”) connected to customer network 110, either directly, or indirectly. Environment 100 may also include a service provider 120 connected to or having access to information relating to customer network 110, an inventory database 130, a product catalog database 140, an energy cost information database 150, a service offerings database 160, and an incentive database 170.

Consistent with embodiments described herein, energy-consuming devices 105 may include any device that consumes power or energy. For example, suitable energy-consuming devices 105 may include networking or information technology (IT) related devices, such as workstations, servers, routers, mainframes, monitors, printers, photocopiers, telephones, cooling systems, etc.

In one implementation, energy-consuming devices 105 may include sensors for monitoring energy consumption in substantially real-time, and may provide the output of the sensors to, for example, service provider 120. In other implementations, energy-consuming devices 105 may be responsive to requests for energy use information via customer network 110. For example, service provider 120 may request energy use information for energy-consuming devices 105 using a network management protocol, such as simple network management protocol (SNMP). In some embodiments, energy-consuming devices 105 may unilaterally transmit energy use information to service provider 120 (or a management device on customer network 110 associated with or accessible to service provider 120).

Customer network 110 may include a local area network (LAN), a wide area network (WAN), a metropolitan area network (MAN), a telephone network, such as the Public Switched Telephone Network (PSTN), an intranet, a portion of the Internet, an optical fiber-based network, or a combination of networks. In some implementations, energy-consuming devices 105 may be specifically related to customer network 110, such as a wide area network (WAN) that supports a customer's business. In still other implementations, customer network 110 may include a power-grid network associated with energy-consuming devices 105.

Service provider 120 may include a network or telecommunication provider configured to receive information regarding customer network 110 and energy-consuming devices 105. As indicated by the dashed line in FIG. 1, in some implementations, service provider 120 may be directly or indirectly connected to customer network 110. In other implementations, service provider 120 may receive the customer network and energy-consuming device information in other manners, such as in response to energy consumption-related surveys. In still other implementations, service provider 120 may derive the information based on information received from non-customer related sources, such as state or government filed documents, etc. Exemplary information may include device information (e.g., device name, type, manufacturer part number, energy requirements, etc.), geographic location information regarding the device information, and location type information (e.g., administrative campus, data center, branch, kiosk, etc.).

Inventory database 130 may include a memory or data structure for storing the information obtained by service provider 120 relating to customer network 110 and energy-consuming devices 105. As will be set forth in additional detail below, exemplary inventory database information may include entries corresponding to energy-consuming devices 105 associated with customer network 110, such as servers, monitors, storage devices, workstations, switches, routers, etc. This information may include specifics relating to each respective device, such as uptime, device name/type, geographic location, etc. The information maintained in inventory database 130 may be searchable based on a variety of criteria, including customer name, device type, average energy used, etc.

Product catalog database 140 may include a memory or data structure for storing energy consumption reference information relating to various energy-consuming devices 105. In one exemplary implementation, the energy consumption reference information is retrieved or otherwise received from an equipment vendor or manufacturer associated with the respective devices. For example, an equipment vendor for a server may provide energy consumption information, e.g., average power consumption, for particular models of servers (e.g., power consuming device 105-1) based on various factors, such as percentage load, operating temperature, etc. The information maintained in product catalog database 140 may be searchable based on a variety of criteria, including device name, vendor name, device type, etc.

Energy cost information database 150 may include a memory or data structure for storing energy cost information corresponding to particular geographic areas, energy types, and energy providers. For example, energy cost information database 150 may include an entry regarding the cost of electricity in Virginia for commercial customers in November of 2009. In other implementations, the stored energy information may further include information relating to the energy provider. Using the above example, energy cost information database 150 may associate the above entry with the average cost for customers of Dominion Virginia Power and the average cost for customers of the Northern Virginia Electric Cooperative (NOVEC). The information maintained in energy cost information database 150 may be searchable based on a variety of criteria, including geographic area (e.g., state, local jurisdiction, etc.), provider name, subscriber type, etc.

Service offerings database 160 may include a memory or data structure for storing information about services offered by or associated with service provider 120. For example, assume that service provider 120 is a network services hosting or managing provider. In this example, service offerings database 160 may include information relating to services, such as data center hosting plans, network management plans, call center management/hosting plans, communications and collaboration consulting services, network colocation services, shared services, Akamai services, remote backup and restore services, etc.

Exemplary information stored about service offerings may include information for calculating a monthly cost/fee for the plan, numbers/types of energy-consuming devices replaced, average personnel/staffing numbers replaced, energy cost estimate information associated with the service offering, etc. For example, information regarding a level 1 hosting service may indicate that the service replaces an average of 25% of the energy-consuming devices and staff positions. The information regarding the level 1 hosting service may also enable accurate estimation of energy costs associated with the service. For example, location information associated with the service offerings may be included as well as detailed energy cost information associated with the service offerings.

Incentive database 170 may include a memory or data structure for storing government incentive information. For example, federal and state governments may offer tax incentives or other benefits (e.g., grants, subsidies, etc.) to organizations that reduce or improve their environmental impact, such as by purchasing or using more efficient technology, reducing emissions, improving energy efficiency, etc. Incentive database 170 may maintain information concerning such rebates or incentives. This information may be used by service provider 120, in the manner described below, to identify incentives for which the customer may qualify. The information maintained in incentive database 170 may be searchable based on a variety of criteria, including jurisdiction, device type, etc.

Consistent with implementations described herein, service provider 120 may include components configured to ascertain and identify improved operations or device configurations for reducing a customer's energy consumption and/or expenditures. More specifically, service provider may: obtain customer inventory based on information retrieved from inventory database 130; estimate utility expenditures associated with the inventory based on information retrieved from product catalog database 140 and energy cost information database 150; and, using information retrieved from incentive database 170, determine whether available service offerings from service offerings database 150 may qualify the customer for tax incentives, rebates, and/or governmental subsidies. Using this information, service provider 120 may automatically generate one or more reports detailing potential future energy savings and/or environmental improvements resulting from changes in their device inventory or other factors, such as facility relocation, consolidation, or outsourcing of various services.

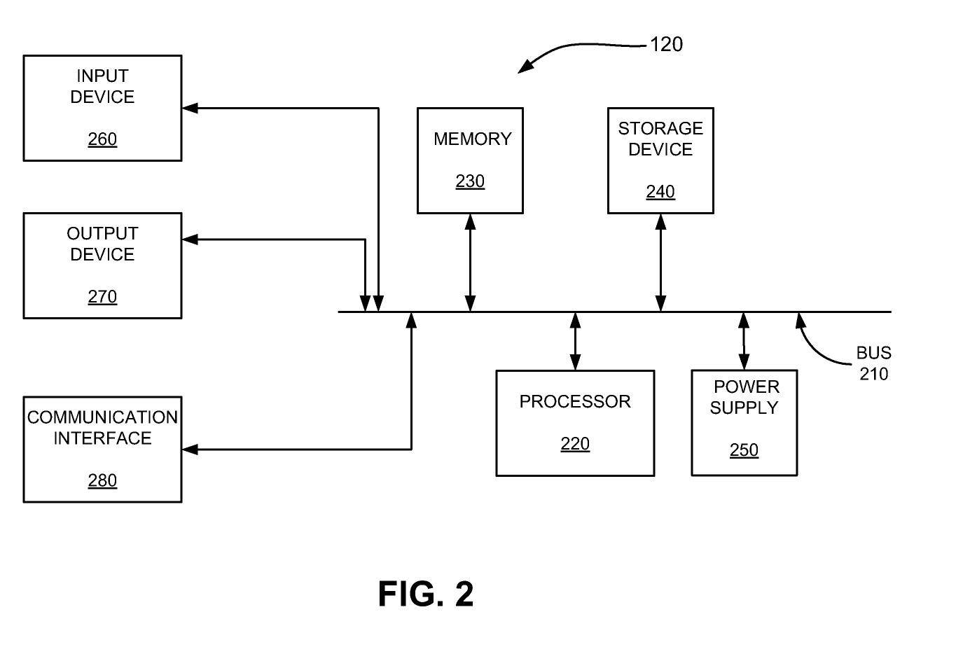

FIG. 2 is a diagram illustrating components of service provider 120. In some implementations, energy-consuming devices 105 and databases 130-170 may include similar components. Referring to FIG. 2, service provider 120 (e.g., a workstation or server device) may include bus 210, processor 220, memory 230, storage device 240, power supply 250, input device 260, output device 270, and communication interface 280. Service provider 120 may be configured in a number of additional ways and may include other or different elements. For example, service provider 120 may include one or more modulators, demodulators, encoders, decoders, etc., for processing data.

Bus 210 may include a path that permits communication among the elements of service provider 120. Processor 220 may include one or more processors, microprocessors, application specific integrated circuits (ASICs), field programmable gate arrays (FPGAs), or other processing logic that may interpret and execute instructions. Memory 230 may include a random access memory (RAM) or another type of dynamic or static (e.g., read only memory (ROM)) storage device that may store information and instructions for execution by processor 220. Storage device 240 may include a magnetic and/or optical recording medium and its corresponding drive. Power supply 250 may include a battery or other power source powering service provider 120.

Input device 260 may permit a user to input information to service provider 120, such as a microphone, a keypad, a keyboard, a touch screen, a mouse, a pen, etc. Output device 270 may output information to the user, such as a display, a printer, one or more speakers, etc.

Communication interface 280 may include a transceiver that enables service provider 120 to communicate with other devices and/or systems, such as databases 130-170 and/or one or more of energy-consuming devices 105. For example, communication interface 280 may include interfaces, such as a modem or Ethernet interface, for communicating via a network, such as customer network 110.

Networks that may be used or managed (e.g., customer network 110) by service provider 120 may include one or more public switched telephone networks (PSTNs) or other type of switched network. The network may further include one or more packet switched networks, such as an Internet protocol (IP) based network, a local area network (LAN), a wide area network (WAN), a personal area network (PAN), an intranet, the Internet, or another type of network that is capable of transmitting data.

In implementations consistent with embodiments described herein, service provider 120 may perform processing associated with ascertaining and identifying improved operations and/or device configurations that may reduce a customer's energy consumption and/or energy expenditures based on information relating to the customer obtained from a number of information sources, such as databases 130-170. In some implementations, service provider 120 may generate, e.g., via a web interface, a tool that enables a user to identify and examine energy consumption for various elements associated with the customer.

Service provider 120 may perform these operations in response to processor 220 executing sequences of instructions contained in a computer-readable medium, such as memory 230. A computer-readable medium may include a physical or logical memory device. The software instructions may be read into memory 230 from another computer-readable medium, such as data storage device 240, or from another device via communication interface 280. The software instructions contained in memory 230 may cause processor 220 to perform processes that are described below. Alternatively, hard-wired circuitry may be used in place of or in combination with software instructions to implement processes consistent with the embodiments described herein. Thus, implementations described herein are not limited to any specific combination of hardware circuitry and software. For the purposes of this application, a “computer” may be defined as a device, or combination of devices, that performs high-speed mathematical or logical operations, or that assembles, stores, correlates, or otherwise processes information.

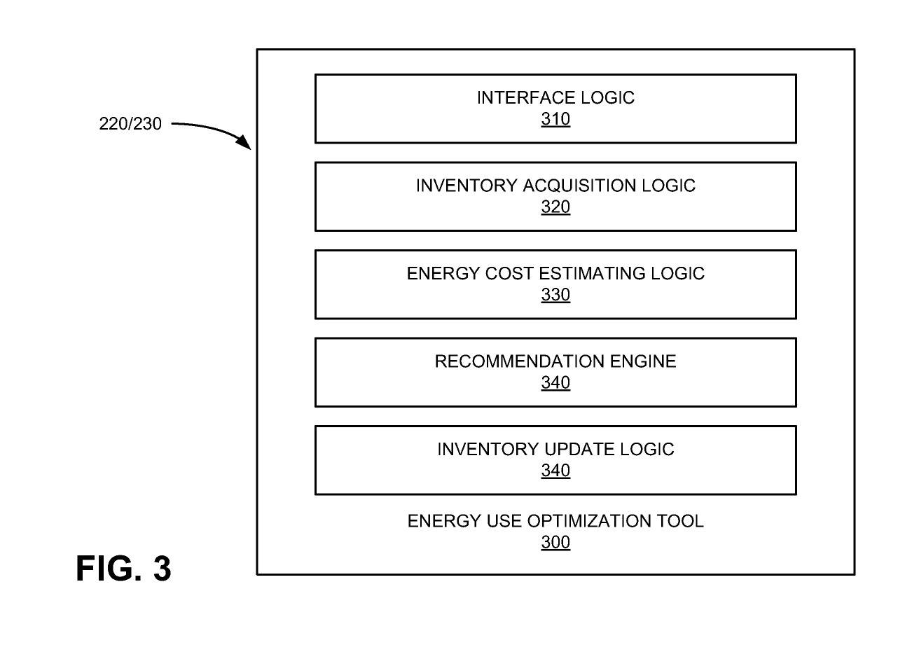

FIG. 3 is a functional block diagram of exemplary components implemented in service provider 120 of FIG. 1. The logical blocks illustrated in FIG. 3 may be implemented in software, hardware, a combination of hardware and software.

Referring to FIG. 3, memory 230 may include an energy use optimization tool 300 that includes interface logic 310, inventory acquisition logic 320, energy cost estimating logic 330, recommendation engine 340, and inventory update logic 350. Various logic components illustrated in FIG. 3 may be implemented by processing logic 220 executing one or more programs stored in memory 230. In some implementations, one or more components of FIG. 3 may be implemented in other devices associated with service provider 120. Energy use optimization tool 300 may include a single executable application or may include more than one executable application.

As discussed in detail below, energy use optimization tool 300 may include logic configured to output information regarding improved operations and/or device configurations for reducing a customer's energy consumption and/or energy expenditures based on information relating to the customer obtained from a number of sources, such as databases 130-170. In one implementation, energy use optimization tool 300 may receive user commands, via a user interface, regarding the information on which its analysis is based.

Interface logic 310 may include logic configured to provide a user with an interface or collection of interfaces associated with energy use optimization tool 300. More specifically, interface logic 310 may provide an interface that allows the user to select a particular customer or customer location on which to perform an energy analysis from the available customers or customer locations.

Selection of a particular customer or customer location may cause inventory acquisition logic 320 to retrieve inventory information associated with the selected customer or customer location. For example, inventory acquisition logic 320 may include logic configured to retrieve, from inventory database 130, inventory information associated with particular devices (e.g., energy-consuming devices 105) based on the selected customer or customer location. For each energy-consuming device 105 in the inventory for the selected customer, the returned inventory information may include various information elements, such as device identification information (e.g., name, type, model number, etc.), uptime or other statistics associated with device 105, and a geographic location associated with the device (e.g., a state, region, or other jurisdiction).

Interface logic 310 may be configured to display at least a portion of the received information via the provided interface. For example, interface logic 310 may provide a listing of the types of devices included in the received inventory information and an estimate of the energy cost associated with each type of device. In some implementations, the provided interface may allow the user to select or otherwise “drill down” into each type of device to view additional information regarding the devices of that type. For example, a device type of “servers” may indicate that there are 1,290 servers associated with the selected customer and that the aggregated energy cost associated with these 1,290 servers is $19,500.48 per month. The provided interface may allow the user to view additional information regarding the 1,290 server devices. The additional information may include information retrieved from inventory database 130, such as device names, model numbers, and an estimated energy cost associated with each device 105.

In one implementation, interface logic 310 may receive energy estimates for each energy-consuming device 105 from energy cost estimating logic 330. Energy cost estimating logic 330 may include logic to calculate estimated energy use information for each device 105 in inventory database 130 based on device information retrieved from inventory database 130, product information retrieved from product catalog database 140, and energy cost information retrieved from energy cost information database 150.

For example, energy cost estimating logic 330 may retrieve a listing of devices associated with a particular customer from inventory database 130. Energy cost estimating logic 330 may also retrieve device energy information from product catalog database 140. For example, energy cost estimating logic 330 may retrieve energy consumption reference information relating to energy requirements for each device 105. In one implementation, the energy consumption reference information may include a range of values corresponding to uptime percentages. For example, a server device 105 may have energy consumption reference information indicating that the server device consumes 0.2 kW/h at 25% uptime, 0.3 kW/h at 50% uptime, 0.4 kW/h at 75% uptime, and 0.5 kW/h at 100% uptime. This information may be used to accurately estimate energy use for energy-consuming devices 105 in the customer's inventory when combined with the inventory information retrieved from inventory database 130.

Energy cost estimating logic 330 may retrieve energy cost information from energy cost information database 150 based on the information received from inventory database 130. For example, energy cost estimating logic 330 may retrieve the energy cost information based on geographic location information associated with each energy-consuming device 105 associated with the selected customer or customer's location and included in inventory database 130.

As described above, energy cost information database 150 may store energy cost information corresponding to a particular location or jurisdiction, such as a state, a region, a county or other municipality. Based on this information, the product energy reference information, and any received uptime or historical energy use information, energy cost estimating logic 330 may calculate or determine an energy cost estimate for each energy-consuming device 105 associated with the selected customer or customer's location and included in inventory database 130.

Interface logic 310 may present the energy cost estimate information via the provided interface. In one implementation, as described above, the energy cost estimate information may be provided in the listing of energy-consuming devices 105 associated with a selected customer or customer location. In one implementation, the aggregate or total energy cost of all energy-consuming devices may also be provided.

Recommendation engine 340 may include logic configured to calculate the energy cost savings/environmental impact for the selected customer based on energy costs resulting from implementation of the available service offerings compared to the customer's current estimated energy costs. For example, recommendation engine 340 may retrieve information regarding service offerings available to the customer from service offerings database 160. Recommendation engine 340 may then calculate the energy savings/environmental impact for the selected customer based on the retrieved service offerings information and information relating to energy-consuming devices 105 associated with the selected customer (e.g., retrieved from inventory database 130, product catalog information, and energy cost estimating logic 330).

For example, recommendation engine 340 may calculate the following recommendation information for each service offering: a revised energy cost estimate for each service offering; a net change in energy-consuming devices (broken down by type of device), a net change in personnel or other service-related, non-energy expenses (e.g., facilities management overhead, personnel expenses, etc.); and a net change in environmental impact, such as net energy consumption change for both the customer and service provider 120 (e.g., a customer's energy use associated with a particular service is 25% greater than service provider's energy use in providing the same service). In some implementations, the net change in environmental impact may be calculated in terms of the customer's “carbon footprint” or CO₂ emissions.

In one implementation, recommendation engine 340 may be configured to retrieve rebate and incentive information from incentive database 160. As described above, incentive database 160 may include information regarding various state and federal governmental tax rebates or other incentives associated with energy reduction initiatives. Recommendation engine 340 may compare the retrieved rebate and incentive information with the energy-related change information calculated by recommendation engine 340. Recommendation engine 340 may determine whether any incentives or rebates may be available to the customer and, if so, may include information regarding the effects of the rebate or other incentive in the recommendation information.

Interface logic 310 may be configured to display the recommendation information generated by recommendation engine 340 based on a user command to view information for one or more of the available service offerings. In one implementation, the displayed results may be used to market service offerings to the customer. In some cases, the recommendation information may be used to market service offerings to individuals not typically marketed to, such as financial control personnel responsible for making energy or utility payments on behalf of the customer.

Inventory update logic 350 may include logic to automatically receive information relating to energy-consuming devices 105. For example, in one implementation, service provider 120 may, via customer network 110, periodically receive information regarding energy consumption of energy-consuming devices. This information may include uptime information, inventory change information, etc. In one implementation, energy-consuming devices 105 may include usage monitoring sensors or other devices for determining energy information for energy-consuming devices 105. The energy information may be exchanged with service provider via SNMP or another suitable protocol. In some implementations, energy-consuming devices 105 may not include discrete sensors, however, logic or software associated with energy-consuming devices 105 may be configured to log and/or store the energy information.

In response to the receipt of energy or inventory information, inventory update logic 350 may update or add information to inventory database 130. For example, information relating to particular energy-consuming devices 105 in inventory database 130 may be updated to reflect the received energy information.

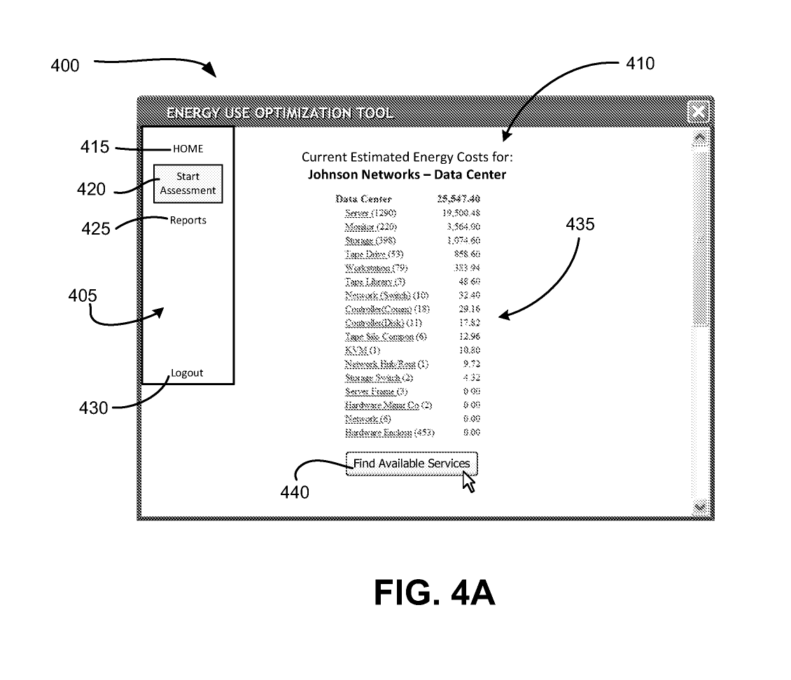

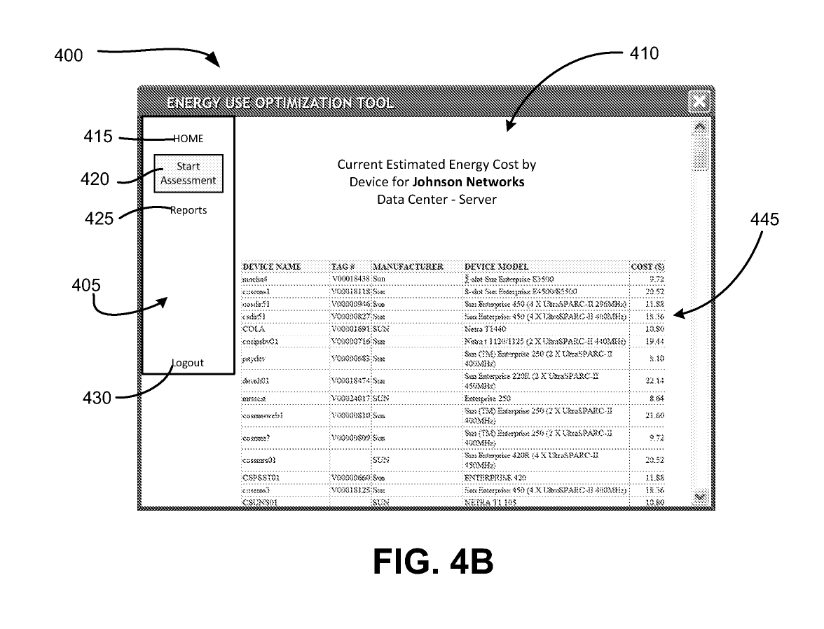

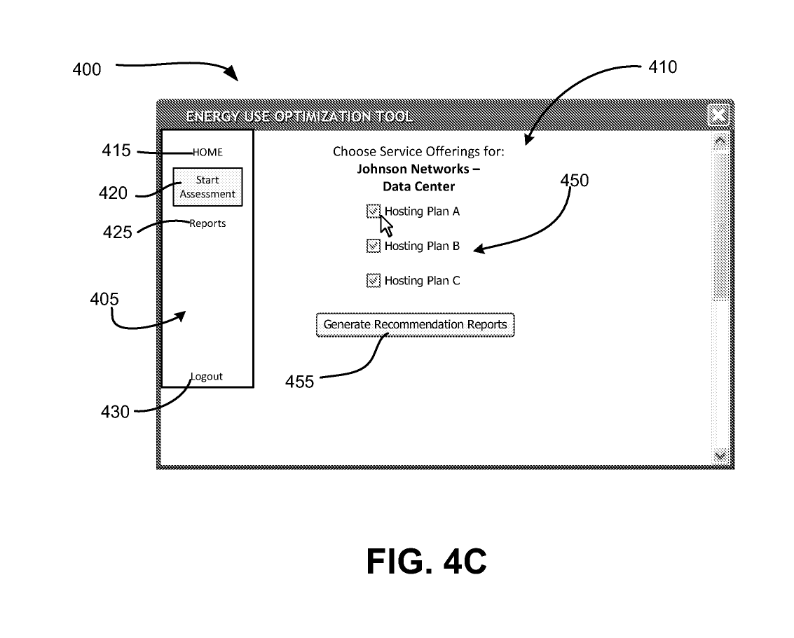

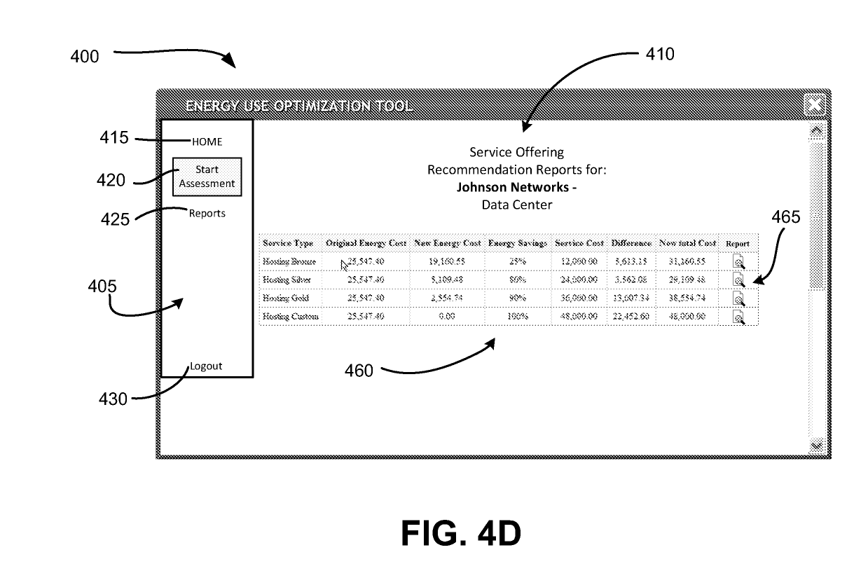

FIGS. 4A-4D depict exemplary interface screens associated with a graphical user interface (GUI) 400 provided by interface logic 310 consistent with implementations described above in relation to FIG. 3. As shown in FIGS. 4A-4D, GUI 400 includes a navigation portion 405 and a content portion 410. Navigation portion 405 provides a user with general navigation options relating to energy use optimization tool 300. Exemplary general navigation options may include a “home” option 415, a “start assessment” option 420, a “reports” option 425, and a “logout” option 430.

Selection of “home” option 415 may cause interface logic 310 to display a first page or interface associated with energy use optimization tool 300. Selection of “start assessment” option 420 may cause interface logic 310 to present a page or interface associated with the start of a service recommendation assessment. In one embodiment, such a page or interface may include a listing of available customers or types of customers for user selection.

Selection of “reports” option 425 may case interface logic 310 to display a page or interface that provides the user with a listing of previously saved assessment reports. As described below, upon generation of a service recommendation report, a user may save the report for retrieval at a later time. Further more, users may update prior service recommendation reports to reflect any new information included in databases 130-170, such as new utility rate information, new tax rebate information, changes in the customer inventory, etc. Selection of “logout” option 430 may log the user out of energy use optimization tool 300.

Content portion 410, depending on the page or portion of energy use optimization tool 300 being used, may display user selection and results information corresponding to a particular customer recommendation assessment. Specifics of various content for display in content area 405 are depicted in FIGS. 4A-4D.

For the purposes of this example, assume that a user has, via other interface screens associated with GUI 400 (not shown), selected a particular customer, customer location, and/or customer facility from a number of available customers/locations/facilities. In this example, the selected customer is Johnson Networks, and the selected facility is Data Center. Further assume that interface logic 310 includes a web server or other device for providing GUI 400 to a user via a user device, such as a workstation, a personal computer, a mobile device, etc. The user device may be associated with or connected to service provider 120 via a network associated with service provider 120. In other implementations, energy use optimization tool 300 may be provided as a stand-alone application executed by processor 220 of service provider 120.

FIG. 4A depicts GUI 400 that provides a user with estimated energy cost information for energy-consuming devices 105 associated with the selected customer/location/facility (e.g., Johnson Networks Data Center). As shown in FIG. 4A, content portion 410 of GUI 400 may include a listing 435 of the types of energy-consuming devices 105 associated with the selected customer/location/facility and a “find available services option” 440. In one implementation, each item in listing 435 may include a descriptive name (e.g., server, monitor, storage, etc.) associated with the particular type of energy-consuming device 105. Moreover, each item in listing 435 may include a link or selection (e.g., a hyperlink) for enabling the user to select, view, or obtain additional information about the selected type of energy-consuming device 105. Additional details regarding the selection of one of the links are set forth below in relation to FIG. 4B.

Selection of “find available services” option 440 may result in interface logic 310 providing an interface for displaying a listing of available service offerings corresponding to or suitable for the selected customer/location/facility. Additional details regarding the selection of “find available services” option 440 are set forth below in relation to FIG. 4C.

As shown in FIG. 4B, upon selection of a link associated with an item in listing 435, interface logic 310 may cause content portion 410 of GUI 400 to display additional information regarding energy-consuming devices 105 associated with the selected customer/location/facility and further corresponding to the selected item in listing 435. For example, content portion 410 may include a table 445 that includes additional information regarding energy-consuming devices 105 of the selected type. In one implementation, table 445 may include information about the device identification, inventory tag, manufacturer, model number, and estimated energy cost for each energy-consuming device 105 of the selected type. As described above, energy cost information for each energy-consuming device in inventory database 130 may be calculated by energy cost estimating logic 330 based on information from inventory database 130, product catalog database 140, and energy cost information database 150. In some implementations, the energy cost information in table 445 may be calculated or generated upon receipt of the identification of a customer in energy use optimization tool 300. In other implementations, the energy cost information in table 445 may be calculated or generated periodically and stored together with inventory information in inventory database 130 for subsequent retrieval by interface logic 310.

As shown in FIG. 4C, upon selection of “find available services” option 440, interface logic 310 may provide a selectable listing 450 of service offerings available to customer for the selected location/facility type and a generate recommendation report option 455. For a data center customer facility, selectable listing 450 may include various levels of network/data center hosting services, depicted as plans A, B, and C in FIG. 4C. For other types of customers or facilities, other types of service offerings may be provided in listing 450, such as web hosting services, network maintenance services, etc.

User interface 400 may allow user selection of one or more of the available service offerings provided in listing 450, for use in generating/presenting a recommendation report based thereon. In the example of FIG. 4C, the user has selected all three available service offerings.

As shown in FIG. 4D, upon selection of “generate recommendation report” option 455, interface logic 310 may cause content portion 410 of GUI 400 to display information regarding energy savings and other environmental/energy related metrics corresponding to the service offerings selected in listing 450. For example, content portion 410 may include a table 460 that includes, for each selected service offering, a comparison of the existing energy cost estimate to a new energy cost estimate generated by recommendation engine 340.

As described above, recommendation engine 340 may calculate a revised energy cost estimate for each service offering; a net change in energy-consuming devices (broken down by type of device), a net change in personnel or other service-related, non-energy expenses (e.g., facilities management overhead, personnel expenses, etc.); and a net change in environmental impact, such as net energy consumption change for both the customer and service provider 120 (e.g., a customer's energy use associated with a particular service is 25% greater than service provider's energy use in providing the same service). In some implementations, the net change in environmental impact may be calculated in terms of the customer's “carbon footprint” or CO₂ emissions.

Some or all of this information may be provided in table 460. The information in table 460 may also include cost information associated with respective service offerings and a total cost estimate based on the revised energy cost estimate and the service estimate. As shown in FIG. 4D, table 460 may include links 465 to reports that provide recommendation information with additional levels of detail including, for example, a breakdown of how the various estimates were calculated.

In some implementations (not shown), table 460 may include rebate or incentive information regarding application tax rebates or state/federal incentives that may be available to the customer based on the environmental changes resulting from a selected service offering. As described above, inventive/rebate information may be stored in incentive database 160 and may be used by recommendation engine 340 to determine possible incentives and/or rebates that the customer may qualify for if a offered service is used or implemented.

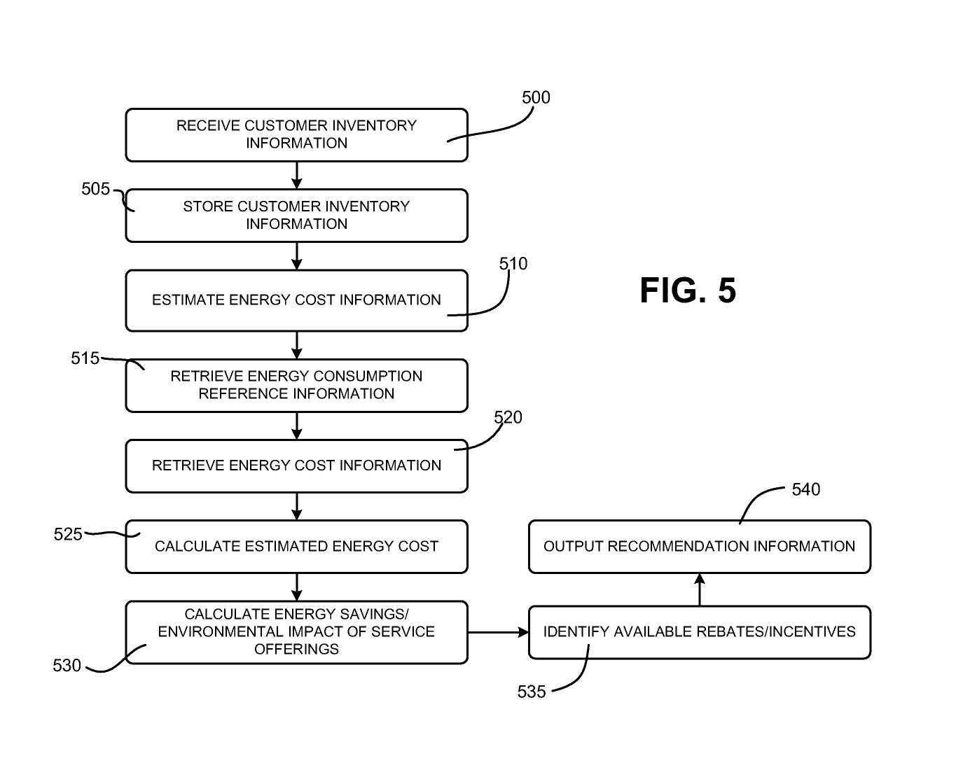

FIG. 5 is a flow diagram illustrating exemplary processing associated with generating energy use recommendation reports in an embodiment described herein. Processing may begin with energy use optimization tool 300 receiving customer inventory information (block 500). As described above, customer inventory information regarding energy-consuming devices 105 associated with the customer may be received by service provider 120 in a variety of manners. In some implementations, the information may be received from the customer in relation to other services currently being provided by service provider 120. In other implementations, energy use optimization tool 300 may query or survey the customer regarding energy-consuming devices 105. In still other implementations, service provider 120 may estimate the customer inventory information based on non-customer sources, such as governmental filings, etc. Once received, energy use optimization tool 300 may store the customer inventory information in inventory database 130 (block 505).

Energy use optimization tool 300 may receive a user request to estimate energy cost information associated with a customer (block 510). For example, interface logic 310 may receive a user request, via GUI 400, of a selected customer, customer location, or customer facility. Energy use optimization tool 300 may retrieve energy consumption reference information for energy-consuming devices 105 associated with the selected customer/location/facility (block 515). In one implementation, energy cost estimating logic 330 may retrieve energy consumption reference information relating to the energy-consuming devices 105 associated with the selected customer/location/facility from product catalog database 140. As described above, product catalog database 140 may be populated with energy consumption reference information retrieved or otherwise received from an equipment vendor or manufacturer.

Energy use optimization tool 300 may retrieve energy cost information corresponding to a particular geographic area associated with the selected customer/location/facility (block 520). For example, energy cost estimating logic 330 may retrieve energy cost information from energy cost information database 150 based on the information received from inventory database 130. For example, energy cost estimating logic 330 may retrieve the energy cost information based on geographic location information associated with each energy-consuming device 105 for the selected customer or customer's location and included in inventory database 130.

Energy use optimization tool 300 may calculate an estimated energy cost associated with the selected customer/location/facility (block 525). For example, energy cost estimating logic 330 may calculate, for each energy-consuming device 105 associated with the selected customer/location/facility, an estimated energy cost based on the information retrieved from inventory database 130, product catalog database 140, and energy cost information database 150.

Energy use optimization tool 300 may calculate the energy savings/environmental impact for the selected customer/location/facility based on estimated energy costs following implementation of the available service offerings compared to the customer's current estimated energy costs and generate recommendation information based on the calculation (block 530). For example, recommendation engine 340 may retrieve information regarding service offerings available to the customer from service offerings database 160 and calculate the energy savings/environmental impact for the selected customer based on the retrieved service offerings information and information relating to customer's inventory information.

Energy use optimization tool 300 may identify incentives and rebates that apply to the selected customer based on the available service offerings (block 535). For example, recommendation engine 340 may compare rebate and incentive information retrieved from incentive database 170 with the energy-related change information calculated by recommendation engine 340 (e.g., in block 530). Recommendation engine 340 may determine whether any incentives or rebates may be available to the customer and, if so, may include information regarding the effects of the rebate or other incentive in the recommendation information.

Energy use optimization tool 300 may output the identified recommendation information to the user (block 540). For example, interface logic 310 may output the recommendation information via GUI 400 in table or report form. The recommendation information may include the energy savings/environmental impact for the selected customer for each of a number of service offerings. Further, as described above, the recommendation information may include information regarding any available rebates or incentives.

Implementations described herein relate to devices, methods, and systems for calculating and presenting energy savings/environmental impact information associated with an organization's operational infrastructure. In one implementation, information may be collected relating to the organization's device inventory, energy costs, service plans, and governmental incentives/rebates. In some embodiments, this information may be obtained automatically using sensors or other monitoring elements associated with the customer devices.

Energy use optimization tool 300 may use the information to calculate energy cost savings and the environmental impact that may result from transferring some or all assets/services from existing infrastructure to offered services. Energy use optimization tool 300 may output the information in an easy to digest manner, usable by sales staff to market the service offerings to various personnel associated with the customer.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

Further, while series of blocks have been described with respect to FIG. 5, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. An energy use optimization tool comprising logic to:
receive inventory information relating to a plurality of customer devices;
store the inventory information;
calculate an estimated energy cost associated with the plurality of customer devices based on the received inventory information;
calculate energy savings or environmental impact information based on energy savings or environmental impact information associated with available service offerings compared to the estimated energy cost; and
output the calculated energy savings or environmental impact information to a user.

2. The energy use optimization tool of claim 1, wherein the logic to receive inventory information comprises logic to:
receive the inventory information from a plurality of sensors associated with the plurality of customer devices,
wherein the plurality of sensors communicate with the energy use optimizing tool via a network.

3. The energy use optimization tool of claim 2, wherein the logic to receive the inventory information from a plurality of sensors is further configured to receive the inventory information on a periodic basis.

4. The energy use optimization tool of claim 1, wherein the inventory information comprises device identification information.

5. The energy use optimization tool of claim 1, wherein the inventory information comprises energy use information for a least a portion of the plurality of customer devices.

6. The energy use optimization tool of claim 1, further comprising logic to:
retrieve manufacturer-provided energy use information for at least one of the plurality of customer devices; and
calculate the estimated energy cost associated with the plurality of customer devices based on the received inventory information and the retrieved manufacturer-provided energy use information.

7. The energy use optimization tool of claim 6, wherein the logic is configured to retrieve the manufacturer-provided energy use information from a product catalog database.

8. The energy use optimization tool of claim 1, further comprising logic to:
retrieve energy cost information associated with a geographic location of the plurality of customer devices; and
calculate the estimated energy cost associated with the plurality of customer devices based on the received inventory information and the retrieved energy cost information.

9. The energy use optimization tool of claim 6, wherein the logic is configured to retrieve the energy cost information from an energy cost information database.

10. The energy use optimization tool of claim 1, wherein the energy savings or environmental impact information comprises a net energy cost difference, a net carbon footprint difference, or a net energy use difference.

11. The energy use optimization tool of claim 1, further comprising logic to:
retrieve incentive or rebate information corresponding to available rebates or incentives;
determine whether a rebate or incentive is available based on the energy savings or environmental impact information; and
output, when the rebate or incentive is available, an indication that the rebate or incentive is available.

13. The energy use optimization tool of claim 1, further comprising:
interface logic to:
output a graphical user interface (GUI) associated with the energy use optimization tool;
receive a user selection of a particular customer associated with the plurality of customer devices via the GUI; and
display a listing the plurality of customer devices and the estimated energy cost associated with the plurality of customer devices via the GUI.

14. The energy use optimization tool of claim 13, wherein the interface logic is further configured to:
receive a user selection of an offered service via the GUI; and
output the calculated energy savings or environmental impact information associated with the offered service via the GUI.

15. A computer-implemented method, comprising:
retrieving, from a first database, inventory information relating to a plurality of customer devices, wherein the plurality of customer devices are associated with a geographic location;
retrieving, from a second database, energy cost information associated with the geographic location;
calculating an estimated energy cost associated with the plurality of customer devices based on the inventory information and the energy cost information;
identifying a service offering associated with the plurality of customer devices;
calculating an estimated service offering energy cost based on energy cost information associated with the identified service offering;
calculating an energy cost savings based on the estimated service offering energy cost compared to the estimated energy cost; and
outputting, to a user, the calculated energy cost savings to a user via a graphical user interface.

16. The computer-implemented method of claim 15, further comprising:
calculating an estimated environmental impact associated with the plurality of customer devices based on the inventory information and the energy cost information;
calculating an estimated environmental impact of the service offering based on environmental impact information associated with the identified service offering;
calculating an environmental impact savings based on the estimated environmental impact of the service offering compared to the estimated environmental impact; and
outputting, to a user, the environmental impact savings to the user via the graphical user interface.

17. The computer-implemented method of claim 16, further comprising:
retrieving incentive or rebate information corresponding to available rebates or incentives;
determining whether a rebate or incentive is available based on the environmental impact savings; and
output, when the rebate or incentive is available, an indication that the rebate or incentive is available.

18. The computer-implemented method of claim 15, further comprising:
receiving the inventory information from a plurality of sensors associated with the plurality of customer devices via a network.

19. A computer-readable medium having stored thereon sequences of instructions which, when executed by at least one processor, cause the at least one processor to:
receive inventory information relating to a plurality of customer devices;
receive a request for energy cost savings information based on the plurality of customer devices and a selected service offering;
calculate first estimated energy cost information associated with the plurality of customer devices based on the received inventory information;
calculate second estimated energy cost information associated with the plurality of customer devices after implementation of the selected service offering;
calculate the energy cost savings information based on the first estimated energy cost savings information compared to the second estimated energy cost savings information; and
output the calculated energy cost savings information to a user.

20. The computer-readable medium of claim 19, wherein the instructions further cause the at least one processor to:
receive the inventory information from a plurality of sensors associated with the plurality of customer devices via a network.
